(19) United States
(12) Patent Application Publication
(10) Pub. No.: US 2019/0387758 A1
(43) Pub. Date: Dec. 26, 2019

(54) Electrically Heated Wooden Barrel Food Smoker

(71) Applicant: Kevin D Clark, Traverse City, MI (US)

(72) Inventor: Kevin D Clark, Traverse City, MI (US)

(21) Appl. No.: 16/450,912

(22) Filed: Jun. 24, 2019

Related U.S. Application Data
(60) Provisional application No. 62/689,943, filed on Jun. 26, 2018.

(51) Int. Cl. A23B 4/056

(52) U.S. Cl. CPC A23B 4/056

(57) ABSTRACT

An electrically heated smoker device is configured from a previously used wooden barrel. The wooden barrel includes interior grills, a drip pan, and a support pan for isolating the elements of the heating device from other elements of the smoker device. A tray of flavor enhancing wood chips may be positioned on the support pan. The wooden barrel is of the type used to store, age and transport alcoholic beverages such as wine or whiskey. The reprocessing of a previously used barrel as a food product smoker includes the benefit of enhancing the flavor of food products being smoked in the smoker device.

### CROSS REFERENCE TO RELATED APPLICATION

This application claims priority in previously filed provisional application 62/689,943, filed Jun. 26, 2018, herein incorporated in its entirety.

### BACKGROUND OF THE INVENTION

### Field of the Invention

A food smoking apparatus and method uses a slow cooking or, alternatively, a smoking technique to prepare meats, vegetables and other foods for human consumption. The core element of the invention is the use of an electric heating element housed in a converted oak spirits-aging barrel.

### SUMMARY OF THE INVENTION

A wooden food smoking and cooking apparatus is constructed from new or previously used wooden barrels sourced from barrel makers, barrel resellers, distilleries, or from wineries. The smoker is heated using an electric heating element. The food being smoked is infused with flavor imparted from the barrel as the interior of the barrel is heated during the smoking operation.

The above summary does not include an exhaustive list of all aspects of the present invention. Indeed, the inventor contemplates that his invention includes all systems and methods that can be practiced from all suitable combinations of the various aspects summarized above, as well as those disclosed in the detailed description below and particularly pointed out in the claims filed with the application. Such combinations have particular advantages not specifically recited in the above summary.

### Objects and Advantages

An advantage of this wooden barrel unit is that is more aesthetically pleasing than metal units. The wooden barrel smoker produces a rich flavor due to the previous use of the barrel for aging wine, bourbon or other spirits.

A further advantage of this invention is that wooden oak barrel food smokers give a special flavor to foods being processed in the wooden barrel unit. Metal smokers do not give off any special flavor. Metal units cannot contain flavor-enhancing properties.

Also an advantage of the wooden barrel food smoker is that the electric heating element is safer than natural gas or propane fired devices.

Furthermore, the electric heating element used in the wooden barrel food smoker produces consistent temperatures that are ideal for smoking and/or cooking foods. In gas fired units it is more difficult to control temperature at a desired setting.

Overall, the advantages of this wooden barrel food smoker are that it is safe and easy to use, simple to maintain, transportable, can be used by a novice or a master chef. It has the capability of slow grilling and smoking fish, beef, game and poultry. It can be used to bake bread, pies, cakes, or pizza and it is great for roasting vegetables, and can be used in making stews, chowders and soups. The unique flavor imparted in the food being processed from gases emanating from the interior of the wooden barrel is one reason that this smoker is more desirable than metal smokers or non-metallic smokers not made from wine or whiskey barrels.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112, 6. Thus, the use of the words “function,” “means” or “step” in the Detailed Description or Description of the Drawings or claims is not intended to somehow indicate a desire to invoke the special provisions of 35 U.S.C. § 112, 6, to define the invention. To the contrary, if the provisions of 35 U.S.C. § 112, 6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112, 6. Moreover, even if the provisions of 35 U.S.C. § 112, 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

The invention will be understood by a reading of the specification along with a review of the drawings in which:

FIG. 1 is a view of the wooden barrel food smoker with the top hinged open to show the interior of the smoker;

FIG. 2 is a depiction of the smoker with various parts expanded away from each other to show the apparatus of the smoker more clearly;

FIG. 3A is a view looking into the smoker from the top showing the grill supports and grill;

FIG. 3B is a detail presentation of the grill and grill support interface;

FIG. 4 is a wooden barrel of the type used in the construction of the smoker;

FIG. 5 is a view into the smoker from the top showing the heating element and other structural components;

FIG. 6 is also a view into the smoker from the top showing a pan and other structural components;

FIG. 7 is a view into the smoker from the top showing a catch pan and catch pan supports as well as other structural components.

### DETAILED DESCRIPTION OF THE INVENTION

The device presented herein is a modified large (53-59 gallon) wooden barrel that is equipped with an electric heating element that maintains a relatively low heat inside the barrel where meat or vegetables are placed to be smoked. The device smokes or, alternatively, cooks foods in a uniformly and safe manner, without the dangers of gas or open flames used to heat the interior of the barrel. The electric heating element, having a thermostatic control element, carried in a lower portion of the barrel supplies a consistent temperature for smoking food. As mentioned above, there is little or no open flame in this wooden barrel smoker unlike smokers using a gas-fired unit.

FIG. 1 is simply a view of the wooden barrel food smoker generally 12. The smoker, preferably, is made from a previously used wine barrel of the type found the world over. It has been found that aged French oak wine barrels work well in this application. However, the country of origin of the barrel is not a significant factor. Used whiskey and bourbon barrels are also preferred candidates for the smoker barrel. The “hard liquor” barrels impart a flavor to the food unlike the flavor imparted when the smoker is a wine barrel.

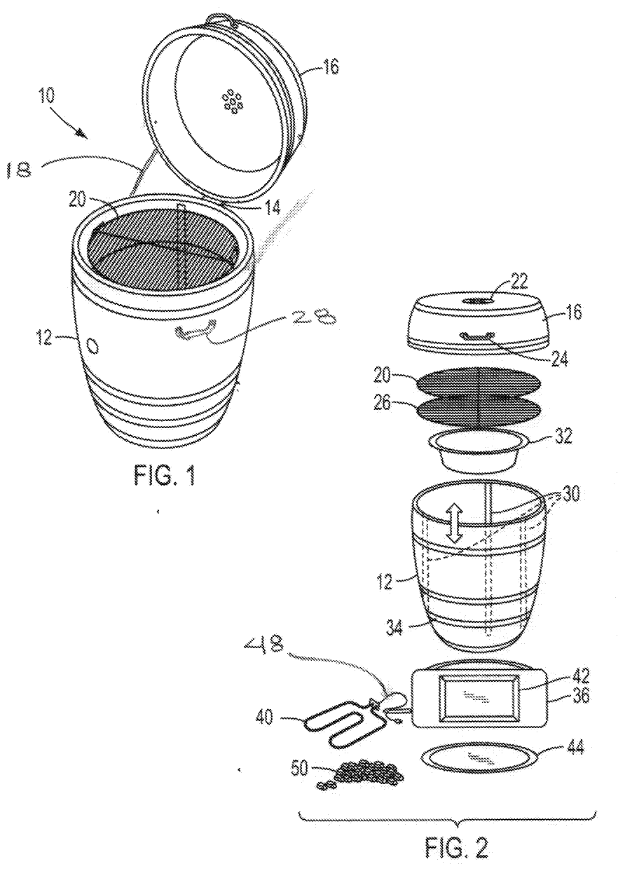

The banded (one of several metal bands shown as item 34 in FIG. 2) wooden barrel, such as previously mentioned, is an oak banded barrel used for storing or aging wine, or other alcohol containing fluids is sawn into two sections, namely a base 12 and a lid or top 16. The lid 16, connected to the base 12 by a hinge 14, is open to provide access to the interior of the base 12 in this figure. One of two or more food-supporting grills, a first one shown as 20 is supported in the base 12 of the wooden barrel 10. A second food-supporting grill 26 is also shown. Two or more grills allow smoking of more than the amount of food that could be positioned on just a single grill. It is also contemplated that a third or fourth food supporting grills (not shown) could be fit into the barrel. This upper-most food-supporting grill 20 is where the food product to be smoked or cooked in the wooden barrel is placed when not using the second grill 26.

FIG. 2 is an expanded illustration of the parts used in the converted wooden barrel to make it into the food smoker. Shown is the barrel top or lid 16. The top or lid 16 is the top portion of the original barrel before the barrel was cut into a base portion 12 and a top portion or lid 16. In one embodiment of the invention the lid has a sidewall that is about twenty-five percent of the original height of the uncut barrel. The top 16 can be “deeper” or “shallower” depending on the current design of the barrel. A damper 22 is fitted to the top of the lid. The damper is a circular disc having a plurality of holes formed in it. The damper 22 is attached to the top surface of the lid using a nut and bolt fastener that is spring loaded by means of a spring carried on the nut and bolt fastener. The wooden top of the barrel has a grouping of holes drilled in the top proximate the damper 22. The damper, and the holes in the damper, can be selectively aligned with the holes in the wooden lid to allow a controlled amount of airflow from inside the smoker to the atmosphere. Temperature inside the smoker barrel can be controlled (in combination with the temperature setting of the heating element 40) by controlling airflow out of the barrel through the damper.

As stated above the top portion and the base of the smoker are hinged together. A handle 24 provides a convenient point for an attendant to open and close the top 16 of the smoker. The handle 24 may be the type of handle used for opening and closing a furnace or a stove. It is made up of an interior portion and a hand contact portion that is wound like a spring presenting a loose fit on the interior portion of the handle.

It is also contemplated that two or more handles, one shown as 28 in FIG. 1, be attached to the base of the barrel. These would be used to lift, move or otherwise handle the entire unit

A safety chain 18 or multiple safety chains or straps may be used to keep the lid from opening too far on its hinges.

The wooden barrel smoker body 12 houses the food supporting grill 20 and depending on the desire of the user of the smoker, a second grill (or even more than a second grill) is mounted below and deeper in the base 12. It is usually positioned so its grill bars are offset, such as at, but not required, ninety-degrees, relative to the grill bars of the food-supporting grill 20. Each of these grills is carried by grill supports 30 mounted to the interior of the base 12. In one embodiment there are three grill supports. The grill supports are fabricated from perforated angle iron stock with grill receiving elongated apertures in the angle iron stock.

Item 32 is a “catch pan.” This pan 32 provides a retainer for water or other fluid, such as, but not limited to, brine, flavored water, or juice such as, but not limited to, apple or cherry juice, used in the processing of the food in the smoker. A second purpose of the catch pan 32 is to catch any drippings from the food being prepared in the smoker. A wok, which has no angular transitions from the sides to the bottom of the wok, makes a good catch pan 32. Several catch pan supports 46 support the catch pan in the barrel.

A lava rock pan 36, generally a bowl shaped pan having a cut-out to allow passage of the heating element electrical supply source, provides the supporting location for the electrical heating element 40, for a layer of lava rock 50, and for locating a perforated wood chip pan 42. The lava rock pan 36 can be rectangular in shape as shown in FIG. 2 or, alternatively, a round pan.

The electric heating element 40, capable of being connected to a source of electrical energy, is a key element of the preferred embodiment of the barrel smoker 10. One reason is that with an electrical heating element there is no open flame in the unit. A second reason is that it is often easier to modulate heating temperature when using an electrical heating element rather than a gas-fired heater or a charcoal fired unit. The electric heating element produces heat to heat the inside of the barrel that will release gases trapped in the barrel staves. It is these released gases that help suffuse the food being process with a unique flavor that can only be accomplished by using a previously used barrel.

A heating element controller is provided to control the temperature of the heat being produced by the heating element 40.

A layer of lava rock 50, or other heat impervious matter, is spread over the coils or elements of the electrical heating element 40.

A wood chip pan 42 may contain flavor enhancing wood chips as desirable when smoking a food item. Wood chips, spread on the wood chip pan 42, can be used to provide enhanced flavor to the food being processed when the wood chips are heated sufficiently to give off smoke.

The base heat shield 44 may be formed as a circular heat shield that fits closely to the inside surface of the base of the barrel 12. A base heat shield 44, similar to a pizza pan, is positioned at the bottom of the barrel. The base heat shield 44 has a diameter close in diameter to the inside diameter of the barrel. The base heat shield 44 has an opening, generally in the lip of the base heat shield, to allow any fluid that finds its way into the base heat shield 44 to drain from the base heat shield through an approximate one-inch drain hole 52 in the side of the barrel.

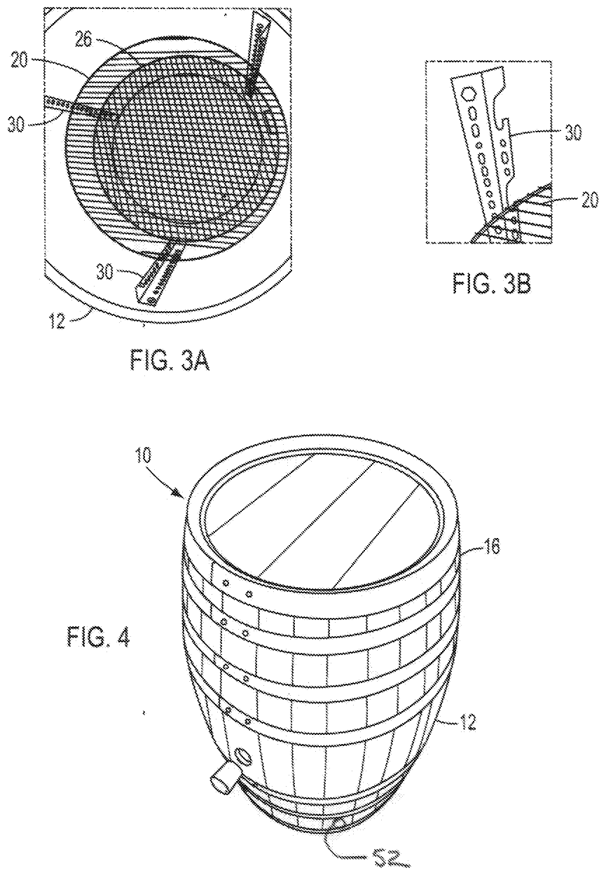

FIGS. 3a and 3b are views looking into the barrel base 12 from the top. The food supporting grill 20 and the second grill 26 are shown supported on the grill supports 30. More food-supporting grills could be used as well. The grill supports 30 are notched (at the top of the grill supports, and also five to ten inches down the grill supports) to hold the two (or more) grills 20 and 26 in place.

In using the wooden barrel smoker 10 it has been found beneficial to lightly dampen the inside of the barrel with water before smoking. This will moisten the barrel. The water released enhances the flavors of the barrel, either the flavor of wine, of bourbon, or of other previous contents of the barrel 10 and swells the barrel staves that make up the barrel to keep the staves tight.

FIG. 4 is simply an unmodified barrel, generally 10, having a lower portion that will become the base portion 12 of the smoker. The eventual top portion or lid 16 is formed from the portion of the basic barrel. The unmodified barrel, a well known structure, is the starting point before converting an unmodified barrel into a smoker. As shown in the other figures, the barrel 10 will be modified by cutting a lid portion 16 from the barrel, adding apertures in the barrel, one for the electric heat element 40 and as second one for a drain aperture. Inside the barrel, at the base of the barrel, there is a base heat shield 44. Vertically above that there is an ash plate or lava rock bowl or pan 36. Above that there is a heating element, a layer of lava rocks, a wood chip pan 42, a catch pan 32, the airflow apertures and the damper 22. Grills, 20 and 26, are supported in the barrel on grill supports 30. On the exterior of the barrel 10, there will be at least one handle and a hinge. A safety chain or strap is also contemplated. It is also contemplated that castors or wheels may be affixed to the base of the barrel 10 to allow the barrel to be easily moved.

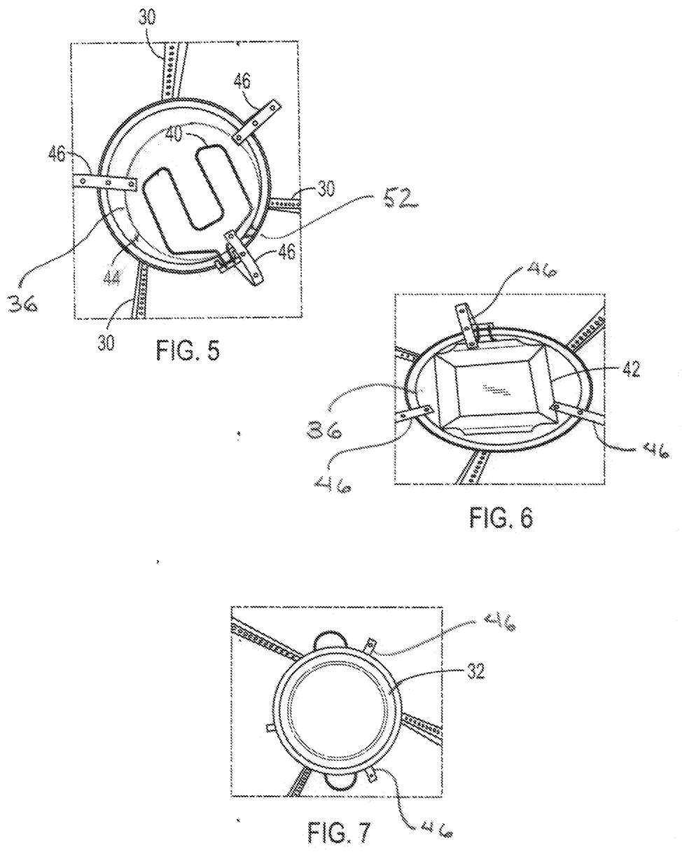

FIGS. 5, 6 and 7 are components at the lower electric heater portion of the device. The heating element 40 shown in FIG. 5 may be a Brinkmann 1500-watt electric heater element or equivalent. Also shown in FIG. 5 are the lava rock pan 36, the grill supports 30, and catch or wok pan supports 46.

The wood chip pan 42 is shown in FIG. 6. FIG. 7 shows the catch pan 32 in position in the smoker unit base portion 12.

In summary, the wooden barrel smoker comprises a wooden barrel cut off below the first or second metal band of the barrel to make a top. The top of the barrel is then fastened to the main part of the barrel with one or more hinges and a limiting chain or chains. A metallic, preferable aluminum base heat shield is placed in the bottom of the barrel.

A 1500-watt heating element is placed on a lava rock pan 36. The heating element 40 comprises a female cord plug receiver as part of the heating element. The female cord plug receiver fits into a rectangular hole formed in the barrel. The female cord plug receiver is screwed into the wall of the barrel at the rectangular hole. The power cord 48 has a male pin that is plugged into the female receiver of the heating element 40. A hole is cut in the barrel to allow a heating element power supply cord to pass through the barrel and through a cutout in the lava rock pan or bowl to the heating element itself. A chip pan is placed on lava spread on the lava rock in the lava rock bowl above the heating element. Above this chip pan a water/drip pan is positioned. “Angle iron-brackets” are attached vertically on three interior sides of the barrel to use as grill support racks. Round grills are placed into slots on the racks. Holes are cut into the top of the barrel and work with a rotatable metering disc to perform as a damper for airflow and to release smoke in a controlled manner from the smoker. The top or lid of the smoker has a handle to lift the lid to access the interior of the barrel.

The wooden barrels presented here as food processing units are portable cookers, most usually for smoking food products, that steam, grill, bake and smoke a wide variety of foods. The wooden barrel smoker is self-contained, safe, portable, and provides a unique flavor to smoked food items.

The invention is, in summary, a food-smoking device for cooking food for consumption that comprises a wooden barrel having a body portion including a top portion and a lower portion. In a preferred embodiment the smoker barrel was previously used for the aging of alcoholic beverages. A hinged top portion of the food-smoking device, the hinged top portion made from the top portion of body of the barrel provides access to the interior of the smoker barrel. Grill units are carried on the inside of the wooden barrel in the lower portion of the barrel. Heat is provided by an electric heating element carried on the inside of the wooded barrel below the grill unit.

While the invention is described herein in terms of preferred embodiments and generally associated methods, the inventor contemplates that alterations and permutations of the preferred embodiments and methods will become apparent to those skilled in the art upon a reading of the specification and a study of the drawings. For instance, the actual shape of the heating elements need not be as shown in the figures but could be configured in another layout or shape.

1. A smoker for processing food products comprises:
a wooden barrel made of barrel staves banded tightly together, the wooden barrel of the type used to age alcoholic spirits;
the wooden barrel cut generally horizontally into a base portion and a top portion;
an electric heating element carried in the base portion of the wooden barrel;
a grill support carried in the base portion of the wooden barrel;
a grill supported in the base portion of the wooden barrel above the electric heating element and below the top portion of the wooden barrel.

2. The invention in accordance with claim 1 further comprising:
a drip pan supported in the base of the wooden barrel below the grill, and
a pan carried in the base of the wooden barrel below the electric heating element.

3. The invention in accordance with claim 2 wherein the pan below the electric heating element supports a layer of lava rock that covers the electric heating element.

4. The invention in accordance with claim 1 wherein the electric heating element comprises a power supply cord and the base of the wooden barrel has an aperture allowing passage of the power supply cord through the base of the wooden barrel.

5. The invention in accordance with claim 1 wherein the wooden barrel is a barrel previously used to contain wine.

6. The invention in accordance with claim 3 further comprising a wood chip pan containing wood chips.

7. The invention in accordance with claim 6 wherein the heating element produces heat to heat the wood chips to sufficient to give off smoke.

8. The invention in accordance with claim 6 wherein the gases released by the heating of the barrel imbue food being processed in the smoker with a flavor derived from the gases released.

9. A smoker for processing food products comprises:
a wooden barrel;
the wooden barrel cut generally horizontally into a base portion and a top portion;
a bowl carried in the base of the wooden barrel;
an electric heating element carried in the bowl, the heating element capable of heating the inside of the wooden barrel;
a layer of lava rock in the bowl, the lava rock carried on top of the electric heating element; wherein the gases released by the heating of the barrel suffuse food being processed in the smoker with a flavor derived from the gases released.
